(19) United States
(12) Patent Application Publication
(10) Pub. No.: US 2008/0013225 A1
(43) Pub. Date: Jan. 17, 2008

(54) Circuit device of an override protection switch

(75) Inventor: Tang-Yueh Hung, Taichung Hsien (TW)

Correspondence Address: TROXELL LAW OFFICE PLLC, SUITE 1404, 5205 LEESBURG PIKE, FALLS CHURCH, VA, 22041, US

(73) Assignee: Zing Ear Enterprise Co., Ltd.

(21) Appl. No.: 11/486,313

(22) Filed: Jul. 14, 2006

(51) Int. Cl. H02H 7/00

(52) U.S. Cl. 361/18

(57) ABSTRACT

A circuit device of an override protection switch, including an operation unit, a rectifying/stabilizing unit, a load voltage sampling unit and a relay. The operation unit includes a comparator and a standard comparison voltage connected to the comparator. The rectifying/stabilizing unit serves to provide DC voltage for the circuit. The load voltage sampling unit has a voltage-dividing sampling section for obtaining a load sampling voltage and outputting the load sampling voltage to the comparator for the comparator to compare the load sampling voltage with the standard comparison voltage. In normal state, the relay keeps the circuit closed. The signal output terminal of the comparator is connected to the relay. With the bulb as the load, in the case that the bulb within the nominal wattage range is used and the load sampling voltage is smaller than the standard comparison voltage, the relay keeps closed to switch on the circuit. In the case that the bulb exceeding the nominal wattage is used and the load sampling voltage is higher than the standard comparison voltage, the comparator outputs a signal to the relay to cut off the circuit.

### BACKGROUND OF THE INVENTION

The present invention is related to a circuit device of an override protection switch, and more particularly to a circuit device of an override protection switch for restricting and distinguishing the power of the bulb. In the case that the wattage of a bulb exceeds a nominal value, the circuit device provides an override protection effect to automatically cut off the load circuit.

It is know that the domestic AC power has nominal voltage. The higher the power of the used bulb is, the more the consumed energy is.

In order to save energy, most people are willing to use those bulbs of smaller power, for example, under 190 wattages. In some countries, it is even regulated or encouraged to use small-power illuminators. However, due to negligence, in some cases, some people will still use large-power bulbs. This leads to waste of energy. In order to solve this problem, it is necessary to provide a measure for a user to easily judge whether the bulb is a small-power one or a large-power one.

### SUMMARY OF THE INVENTION

It is therefore a primary object of the present invention to provide a circuit device of an override protection switch for judging the power of the bulb. In the case that the wattage of a bulb exceeds a nominal value, the circuit device provides an override protection effect to automatically cut off the load circuit.

The present invention can be best understood through the following description and accompanying drawings wherein:

### BRIEF DESCRIPTION OF THE DRAWINGS

FIG. 1 is a circuit diagram of a preferred embodiment of the present invention;

FIG. 2 is a perspective view of the override protection switch of the present invention; and

FIG. 3 is a perspective exploded view of FIG. 2.

### DETAILED DESCRIPTION OF THE PREFERRED EMBODIMENTS

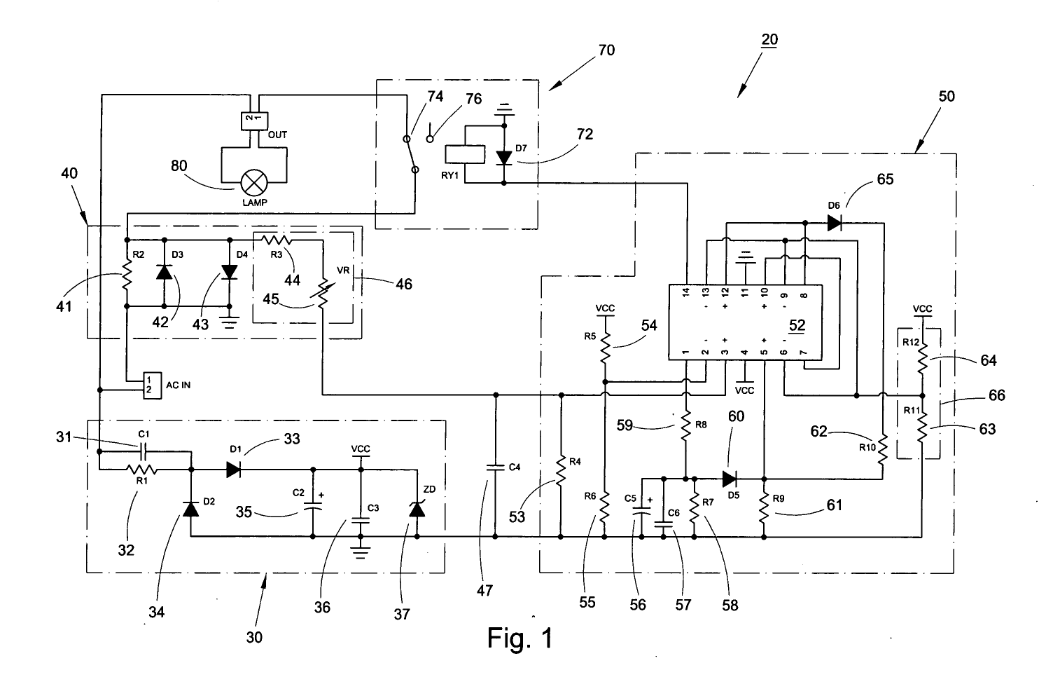

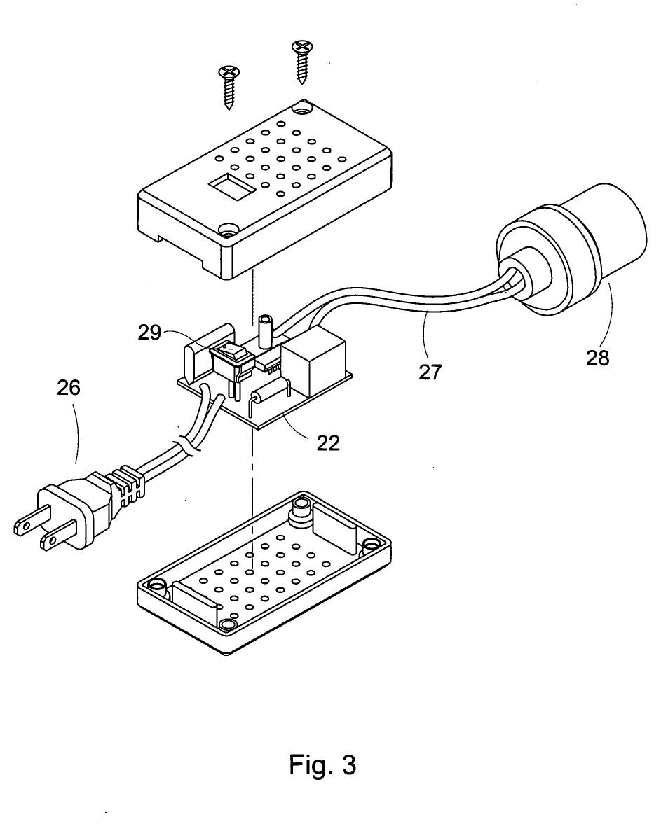

Please refer to FIG. 1 which is a circuit diagram of the circuit device 20 of the present invention. The circuit device 20 can be made as a circuit board 22 as shown in FIG. 3. The circuit board 22 is connected with a power input terminal 26 and a power output terminal 27. The power output terminal 27 is connected to a bulb holder 28 in which a bulb is installable to form an override protection switch 25 applicable to a light.

The circuit device 20 includes a rectifying/stabilizing unit 30, a load voltage sampling unit 40, an operation unit 50 and a relay 70. The operation unit 50 includes an IC comparator 52. In this embodiment, the IC comparator 52 is an integrated circuit under Model No. LM324. The comparator 52 has 14 contacts and four inbuilt operation amplifiers. The contacts 2 and 3 are the input terminals of the first set of operation amplifier, while the contact 1 is the output terminal thereof. The contacts 5 and 6 are the input terminals of the second set of operation amplifier, while the contact 7 is the output terminal thereof. The contacts 9 and 10 are the input terminals of the third set of operation amplifier, while the contact 8 is the output terminal thereof. The contacts 12 and 13 are the input terminals of the fourth set of operation amplifier, while the contact 14 is the output terminal thereof. The contact 11 is grounded.

The rectifying/stabilizing unit 30 includes a first capacitor 31, a first resistor 32, a first diode 33, a second diode 34, a second capacitor 35, a third capacitor 36 and a Zener diode 37. The input terminal of the rectifying/stabilizing unit 30 is connected to the input terminal 26 of an AC power source. The output terminal of the rectifying/stabilizing unit 30 is connected to the operation unit 50. The AC power is pulled down by the first capacitor 31 and the first resistor 32 and rectified, filtered and stabilized by the first and second diodes 33, 34, the second and third capacitor 35, 36 and the Zener diode 37 into 11V DC voltage as the necessary working voltage.

The load voltage sampling unit 40 is connected to the input terminal 26 of the AC power source and is composed of a second resistor 41, a third diode 42, a fourth diode 43, a third resistor 44 and a variable resistor 45. In loaded state, the second resistor 41 provides a pull-down effect. The third and fourth diodes 42, 43 provide great current protection effect to avoid too great leakage. The third resistor 44 and the variable resistor 45 form a voltage-dividing sampling section 46 for obtaining a load sampling voltage. The value of the load sampling voltage is adjustable by means of the variable resistor 45. For example, the voltage can be adjusted to 160 W or 180 W. The output terminal of the sampling unit 40 is connected to the contact 3 of the comparator 52 of the operation unit 50, which is the positive electrode input terminal of the first set of operation amplifier.

A fourth capacitor 47 is connected with the output terminal of the load voltage sampling unit 40 to provide a filtering effect for the sampling unit 40 so as to avoid mis-operation caused by poor signals.

Besides the IC comparator 52, the operation unit 50 further includes a fourth resistor 53, a fifth resistor 54, a sixth resistor 55, a fifth capacitor 56, a sixth capacitor 57, a seventh resistor 58, an eighth resistor 59, a fifth diode 60, a ninth resistor 61, a tenth resistor 62, an eleventh resistor 63, a twelfth resistor 64 and a sixth capacitor 65. The fourth resistor 53 provides a pull-down effect. The fifth and sixth capacitors 56, 57 serve to eliminate ripple interference and wave current. The eleventh resistor 63 and the twelfth resistor 64 are serially connected. The contact between the two resistors 63, 64 serves as a standard comparison voltage 66. The value of the standard comparison voltage 66 is compared with the sampling voltage of the voltage-dividing sampling section 46 of the sampling unit 40. The standard comparison voltage 66 is connected to the contacts 2, 6, 9 and 13 of the comparator 52, which respectively are the negative electrode input terminals of the four sets of operation amplifiers. The positive electrode of the fifth diode 60 is connected to the contact 1 of the comparator 52, while the negative electrode of the fifth diode 60 is connected to the contact 5 of the comparator 52. The polarity of the sixth diode 65 is reverse to the fifth diode 60. The positive electrode of the sixth diode 65 is connected to the contacts 8 and 12 of the comparator 52, while the negative electrode of the sixth diode 65 is connected to the contact 5 of the comparator 52 to provide a feedback effect.

Two terminals of the relay 70 are respectively connected to the contact 14 of the comparator 52 of the operation unit 50 and the AC power source. The contact 14 is the output terminal of the fourth set of operation amplifier of the comparator 52. In normal state, the relay 70 is always closed to switch on the circuit. A seventh diode 72 is parallelly connected with the relay for restraining the anti-peak voltage of the coil and protecting the relay.

The operation of the present invention is described hereinafter. The circuit device of the present invention is applicable to a light to achieve a current-limiting effect. In this embodiment, a bulb under 190 watts (not limited) is used. In the case that the bulb as the load is over 190 watts, the bulb will be turned on for a moment and then extinguished.

In the case that a bulb under 190 watts serves as a load, after powered by the AC power supply, the first set of operation amplifier of the comparator 52 of the operation unit 50 will compare the voltage. In loaded state, the voltage-dividing sampling section 46 of the load voltage sampling unit 40 obtains a load voltage and inputs the load voltage into the contact 3 of the comparator 52. The load voltage is compared with the standard comparison voltage 66 connected to the contact 2 of the comparator 2. At this time, the load is within the nominal working range of the circuit so that the first set of operation amplifier of the comparator 52 will compare the voltage of the contact 3 with the voltage of the contact 2 to find that the voltage of the contact 3 is lower than the voltage of the contact 2. Under such circumstance, the circuit device 20 is in a working state and the contact 74 of the relay 70 is closed to switch on the circuit to turn on the bulb 80.

In the case that the load of the bulb exceeds the nominal working range, for example, higher than 190 watts, the first set of operation amplifier of the comparator 52 will compare the voltage of the contact 3 with the voltage of the contact 2 to find that the voltage of the contact 3 is higher than the voltage of the contact 2. Under such circumstance, the output terminal of the first set of operation amplifier, that is, the contact 1, outputs high potential into the contact 5 of the comparator. After compared by the second set of operation amplifier of the comparator 52, the contact 7 outputs high potential into the contact 10. Then, after compared by the third set of operation amplifier of the comparator 52, the contact 8 outputs high potential into the contact 12. And after compared by the fourth set of operation amplifier of the comparator 52, the contact 14 outputs high potential for driving the relay 70 to work. At this time, the relay 70 is switched to the contact 76 to cut off the circuit and turn off the bulb.

In the case of override, the relay 70 cuts off the load circuit for automatic protection. At this time, the contact 1 of the comparator 52 turns to output low potential, while the sixth diode 65 provides a feedback effect to keep the contacts 5, 7, 8 and 14 of the comparator 52 outputting high potential, whereby the relay 70 keeps switched off to cut off the load circuit.

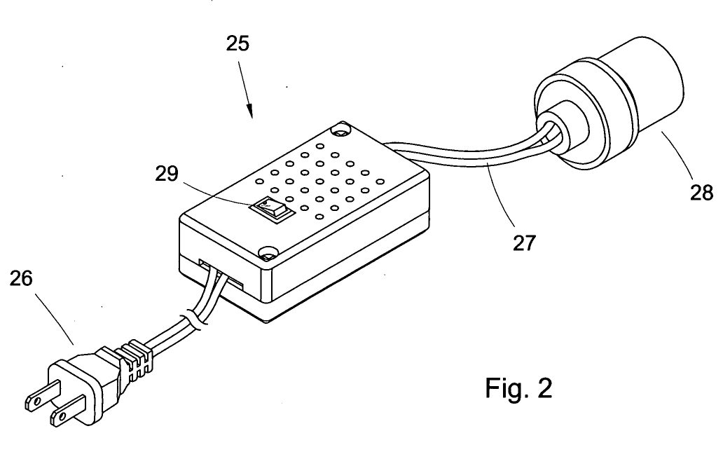

When it is desired to restore the circuit device 20 back to its working state, a user must stop from supplying the AC power. For example, the user must switch off the switch 29 of the protection switch 25 as shown in FIG. 2 or unplug the plug. After powered off for several seconds, the relay 70 is switched to the contact 74 and restored to the closed state. A bulb under 190 watts can be installed and then powered on. The device is then back to its working state, the bulb lights up.

By means of the present invention, a user can easily judge whether the bulb pertains to high power or low power. This can minimize the possibility of human negligence. The relay of the circuit device serves as the on-off switch of the load circuit. In the case of small wattage bulb, the bulb can be normally used and turned on. Reversely, in the case of large wattage bulb, the bulb will be turned on for a moment and then extinguished. This reminds the user that the wattage of the bulb is too great to save energy. The lighting time of the override bulb is determined by the exceeding wattage. The more the exceeding wattage is, the shorter the lighting time is. In the case of override bulb, after powered off for about five seconds and the bulb is replaced with a bulb under the load, the plug can be re-plugged into the socket to turn on the bulb.

The above embodiments are only used to illustrate the present invention, not intended to limit the scope thereof. Many modifications of the above embodiments can be made without departing from the spirit of the present invention.

What is claimed is:

1. A circuit device of an override protection switch connectable to a bulb, whereby a bulb within a nominal wattage range can be normally used, while the circuit will be opened in the case of a bulb exceeding the nominal wattage range, the circuit device comprising:
an operation unit including a comparator and a standard comparison voltage, the comparator serving to compare a voltage with the standard comparison voltage, the standard comparison voltage being connected to the comparator;
a rectifying/stabilizing unit, an input terminal of the rectifying/stabilizing unit being connected to an input terminal of an AC power source, while an output terminal of the rectifying/stabilizing unit being connected to the operation unit for providing DC voltage;
a load voltage sampling unit connected to the AC power source and having a voltage-dividing sampling section for obtaining a load sampling voltage, the output terminal of the voltage-dividing sampling section being connected to the comparator of the operation unit, whereby the comparator can compare the load sampling voltage with the standard comparison voltage; and
a relay connected to the AC power source, in normal state, the relay keeping closed to switch on the circuit, the signal output terminal of the comparator of the operation unit being connected to the relay, whereby in the case that the load sampling voltage is smaller than the standard comparison voltage, the relay keeps closed to switch on the circuit, while in the case that the load sampling voltage is higher than the standard comparison voltage, the signal output terminal of the comparator switches off the relay to cut off the circuit.

2. The circuit device as claimed in claim 1, wherein the value of the load sampling voltage obtained by the voltage-dividing sampling section of the load voltage sampling unit is adjustable.

3. The circuit device as claimed in claim 2, wherein the voltage-dividing sampling section is composed of a resistor and a variable resistor.

4. The circuit device as claimed in claim 1, wherein the operation unit comprises two serially connected resistors; a contact between the two resistors serves as the standard comparison voltage.

5. The circuit device as claimed in claim 1, wherein the operation unit further includes a diode connected between an input terminal and output terminal of the comparator for providing a feedback effect, whereby in the case of override, the relay keeps cutting off the load circuit.

6. The circuit device as claimed in claim 1, wherein the nominal wattage range is 190 watts.
